(19) United States
(12) Patent Application Publication
(10) Pub. No.: US 2024/0107031 A1
(43) Pub. Date: Mar. 28, 2024

(54) METHODS AND APPARATUS TO UTILIZE CACHE IN DYNAMIC IMAGE ENCODING

(71) Applicant: Intel Corporation, Santa Clara, CA (US)

(72) Inventors: Stanley Baran, Chandler, AZ (US); Jason Tanner, Folsom, CA (US); Venkateshan Udhayan, Portland, OR (US); Chia-Hung S. Kuo, Folsom, CA (US)

(21) Appl. No.: 18/525,001

(22) Filed: Nov. 30, 2023

(51) Int. Cl. H04N 19/159; G06T 7/62; H04N 19/167

(52) U.S. Cl. CPC H04N 19/159; G06T 7/62; H04N 19/167

(57) ABSTRACT

An example apparatus determines a size of a dirty region of a video frame; after the size of the dirty region satisfies a threshold: encode the dirty region of the video frame to generate an encoded dirty region; and cause storing of the dirty region in the cache; and after the size of the dirty region does not satisfy the threshold: cause storing of the video frame in a volatile memory that is separate from the cache; and encode the video frame via inter-encoding to generate an encoded video frame.

### FIELD OF THE DISCLOSURE

This disclosure relates generally to electronic devices and, more particularly, to methods and apparatus to utilize cache in dynamic image encoding.

### BACKGROUND

An electronic user device such as a laptop or a mobile device includes a camera to capture images and a display screen to display images. The camera and/or display screen can be used during a call in which images of the user of the device and/or the contents of their display screen are transmitted to other user devices.

### BRIEF DESCRIPTION OF THE DRAWINGS

FIG. 1 illustrates a block diagram of example user devices connected via a network.

FIG. 2 illustrates an example system constructed in accordance with the teachings of this disclosure in which a user device includes example image processing circuitry.

FIG. 3 illustrates example image frames encoded by the example image processing circuitry of FIG. 2.

FIG. 4 illustrates another example of image frames encoded by the example image processing circuitry of FIG. 2.

FIG. 5 is a flowchart representative of example machine readable instructions and/or example operations that may be executed, instantiated, and/or performed by example programmable circuitry to implement the example image processing circuitry of FIG. 2.

FIG. 6 is another flowchart representative of example machine readable instructions and/or example operations that may be executed, instantiated, and/or performed by example programmable circuitry to implement the example image processing circuitry of FIG. 2.

FIG. 7 is a block diagram of an example processing platform including programmable circuitry structured to execute, instantiate, and/or perform the example machine readable instructions and/or perform the example operations of FIGS. 5-6 to implement the local user device 102 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

An electronic user device such as a laptop, tablet, or smartphone includes a camera and/or a video card (e.g., video card circuitry, a graphics card, a graphics processing unit (GPU)). The user device may include user applications such as a video conferencing application installed thereon. During, for instance, a conference or call, the camera (e.g., a built-in video camera, a separate camera that is an accessory to the input device, etc.) and/or the video card of the user device generates images of the user and/or contents of a display screen (e.g., a document, a webpage, etc.) of the user device. The user device encodes and transmits the images to one or more devices (e.g., laptops, tablets, smartphones, etc.) participating in the conference. Each of the one or more conferencing devices also includes a camera and/or a video card. During the video conference, the cameras of the one or more conferencing devices generate images of respective users of the video conferencing devices. Additionally or alternatively, during the conference, the video cards of the one or more conferencing devices generate images of the contents of the display screen. Accordingly, the one or more conferencing devices can encode and transmit the images to the user device. For example, during a video conferencing session, the conferencing devices encode and transmit the images captured by the camera to other user device(s) in the conference. Similarly, when one or more of the conferencing devices is screen sharing, the conferencing device(s) encode and transmit the images of the contents of the display screen to the other user device(s) in the conference. After receiving the images, the user device(s) decode(s) and display(s) the images received from the conferencing output device(s) on a display screen of the user device.

Encoding the image generated by the camera and/or the video card of the user device can use a large amount of processing power of the user device. In some examples, a significant portion of the processing power is related to memory bandwidth usage which employs power-consuming memory resources such as double data rate input/output (DDRIO) and memory controller power. For example, in known video conferencing encoding pipelines, an entire video frame (e.g., a 1080p resolution image) may be read to and/or written from the memory numerous times. In some examples, video conferencing applications use a high frame rate (e.g., 30 frames per second). As a result, the conferencing application can use a significant portion (e.g., 15 percent) of the power consumption of the user device for processing images generated by the camera and/or the video card.

Additionally, decoding the images received from the conferencing devices at the user device can use a large amount of processing power of the user device related to memory bandwidth. For example, in known conferencing decoding and display pipelines, an entire video frame (e.g., a 720p resolution image) may be read from and/or written to the memory several (e.g., four or more) times. In some examples, a video conference can include a plurality of participants such that the user device receives images from a plurality of video conferencing devices. Therefore, the number of reads from and/or writes to the memory or entire video frames is multiplied by the number of additional participants (e.g., the number of video conferencing devices). Additionally, with the high frame rate (e.g., 30 frames per second) used for video conferencing and/or screen sharing, the conferencing application can use a significant portion (e.g., 15 percent) of the power consumption of the user device for the decoding and display pipeline. In total, the conferencing application can use a significant portion (e.g., 30 percent) of the power consumption of the user device for combined encoding and decoding pipelines.

In some examples, a first portion of an image (e.g., a dirty region of the image) generated by the camera and/or video card of a user device or the camera(s) and/or video card(s) of the video conferencing device(s) includes changes relative to a previous frame (e.g., a dirty region of the image) and a second portion of the image is substantially unchanged from the previous frame (e.g., a static region of the image). Examples disclosed herein reduce memory bandwidth usage and power consumption during video conferencing and/or screen sharing by omitting and/or reducing the frequency of reading and/or writing the second portion of the image. Examples disclosed herein reduce memory bandwidth usage when a user device is processing (e.g., encoding) an image captured by a camera and/or displayed via a display screen of the user device during screen sharing and/or video conferencing. Additionally, examples disclosed herein reduce memory bandwidth when a user device is decoding and displaying images received from other user devices during the screen sharing and/or video conferencing.

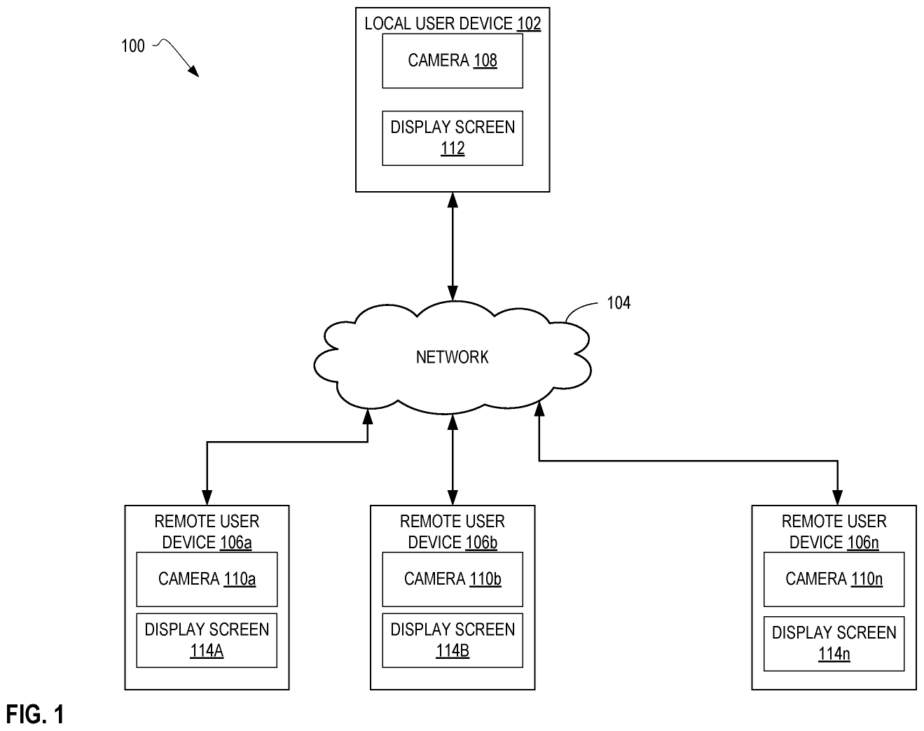

FIG. 1 illustrates an example system 100 including connected user devices that can implement examples disclosed herein. In the example of FIG. 1, an example local user device 102 (e.g., a laptop computer, a smartphone, a desktop computer, an electronic tablet, a hybrid or convertible computer, etc.) is connected via a network 104 to a plurality of remote user devices 106a,b,n (e.g., laptops, smartphones, etc. associated with other participants of the video conference). The example local user device 102 includes a camera 108 and a display screen 112. During, for example, a video conference, the camera 108 can generate images associated with the example local user device 102, such as images including a user (not shown) of the example local user device 102. Additionally, the user device 102 can generate images that are then presented via the display screen 112, such as images of webpages, documents, applications, and/or other content that the user is accessing via the user device 102. The example local user device 102 can process (e.g., perform image processing, encoding, etc.) the image and transmit the image via the network 104 to the remote user devices 106a,b,n. As explained above, processing the image can use a significant portion (e.g., 15 percent) of the power consumption of the local user device 102.

Additionally, each of the example remote user devices 106a,b,n includes a camera 110a,b,n and a display screen 114a,b,n. Each of the cameras 110a,b,n can generate images associated with the respective remote user device 106. For example, the camera 110a can capture an image of a user (not shown) of the remote user device 106a. Additionally, each of the user devices 106a,b,n can generate images for presentation via the display screens 114a,b,n. Subsequently, each of the example remote user devices 106a,b,n can process (e.g., perform image processing, encoding, etc.) and transmit the images captured by the respective cameras 110a,b,n and/or presented via the display screens 114a,b,n to the local user device 102 via the network 104. As such, the example local user device 102 receives the plurality of images from the remote user devices 106a,b,n. During a call (e.g., a screen sharing call, a video conference call), the example local user device 102 processes (e.g., decodes, combines, displays, etc.) and displays the plurality of images. As explained above, processing the plurality of images received from the remote user devices 106a,b,n can use a significant (e.g., 15 percent) of the power consumption of the local user device 102.

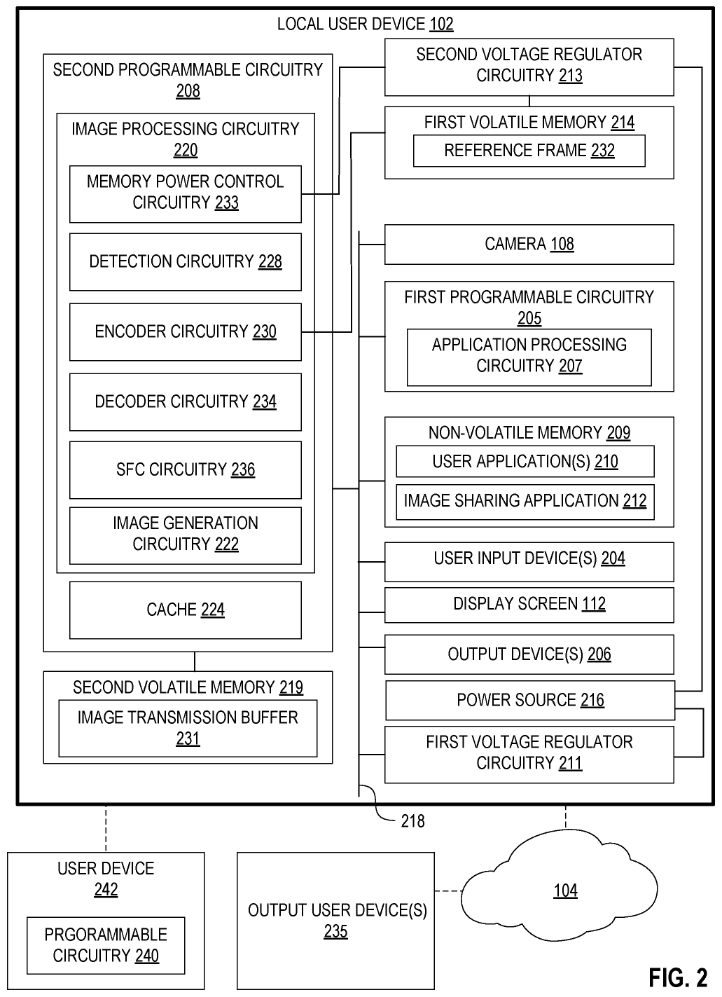

FIG. 2 illustrates the example local user device 102 constructed in accordance with teachings of this disclosure for processing images associated with an image transmission call (e.g., a screen sharing call, a video conference, etc.) on a user device. As discussed in connection with FIG. 1, the local user device 102 can be a personal computing device such as a laptop, a desktop computer, an electronic tablet, a smartphone, etc. Although FIG. 2 shows details of the example local user device 102, remote user devices 106a,b,n are substantially similar or identical to the local user device 102.

The example local user device 102 includes multiple components described below. Some of the components are connected to one another via a bus 218, which communicates information between those components. The local user device 102 includes one or more user input device(s) 204. The user input device(s) 204 include(s) a touch screen interface that enables a user to interact with content (e.g., data) presented on the display screen 112 by touching the display screen 112 with a stylus and/or one or more fingers or a hand of the user. Additionally or alternatively, the user input device(s) 204 may include a microphone(s), a keyboard, a mouse, a touch pad, etc. The example local user device 102 includes one or more output device(s) 206 such as speaker(s) to provide audible outputs to the user of the local user device 102.

The example local user device 102 of FIG. 2 includes first programmable circuitry 205 and second programmable circuitry 208. The first programmable circuitry 205 and the second programmable circuitry 208 of FIG. 2 may be instantiated (e.g., creating an instance of, bring into being for any length of time, materialize, implement, etc.) by programmable circuitry such as a Central Processor Unit (CPU) and/or a Graphics Processor Unit (GPU) executing first instructions. For example, the first programmable circuitry 205 can be instantiated by a CPU, and the second programmable circuitry 208 can be instantiated by a GPU. Additionally or alternatively, the first programmable circuitry 205 and the second programmable circuitry 208 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the first programmable circuitry 205 and the second programmable circuitry 208 of FIG. 2 may, thus, be instantiated at the same or different times. Some or all of the first programmable circuitry 205 and the second programmable circuitry 208 of FIG. 2 may be instantiated, for example, in one or more threads executing concurrently on hardware and/or in series on hardware. Moreover, in some examples, some or all of the first programmable circuitry 205 and the second programmable circuitry 208 of FIG. 2 may be implemented by microprocessor circuitry executing instructions and/or FPGA circuitry performing operations to implement one or more virtual machines and/or containers.

In the illustrated example of FIG. 2, the first programmable circuitry 205 executes machine readable instructions (e.g., software) including, for example, a user application(s) 210 (e.g., an Internet browser(s), productivity applications (e.g., Microsoft suite applications), etc.) and an image sharing application 212 (e.g., a video conferencing application, a screen sharing application, a gaming application, etc.) installed on the local user device 102. In this example, the user application(s) 210 and the image sharing application(s) 212 are stored in a non-volatile memory 209 (e.g., flash memory). The first programmable circuitry 205 includes application processing circuitry 207 to execute the machine readable instructions associated with the user application(s) 210 and the image sharing application 212. In some examples, the application processing circuitry 207 identifies particular machine readable instructions of the user application(s) 210 and/or the image sharing application 212 that are to be executed (e.g., determines application operations that are to be performed) based on an input from the user input device(s) 204.

The example local user device 102 of FIG. 2 includes a power source 216 such as a battery and/or transformer and AC/DC converter, to provide power to the programmable circuitry 208 and/or other components of the local user device 102. In this example, the power source 216 provides power to first voltage regulator circuitry 211 and second voltage regulator circuitry 213. The first voltage regulator circuitry 211 and the second voltage regulator circuitry 213 control a voltage and/or electrical current provided to the components of the local user device 202. The first voltage regulator circuitry 211 is connected to the bus 218 and controls the voltage and/or electrical current provided to the programmable circuitry 208 and other components that are connected to the bus 218. In some examples, the first voltage regulator 211 includes distinct voltage regulators for the different components connected to the bus 218. The second voltage regulator circuitry 213 is connected to a first volatile memory 214 and controls the voltage and/or electrical current provided thereto, as discussed in further detail below.

As disclosed in connection with FIG. 1, the camera 108 of the local user device 102 generates image data including image captures. For example, the image captures can include pictorial representations of one or more users of the local user device 102. The second programmable circuitry 208 includes the image processing circuitry 220, which can process an image(s) generated by the camera 108 of the local user device 102 (e.g., during use of the image sharing application 212).

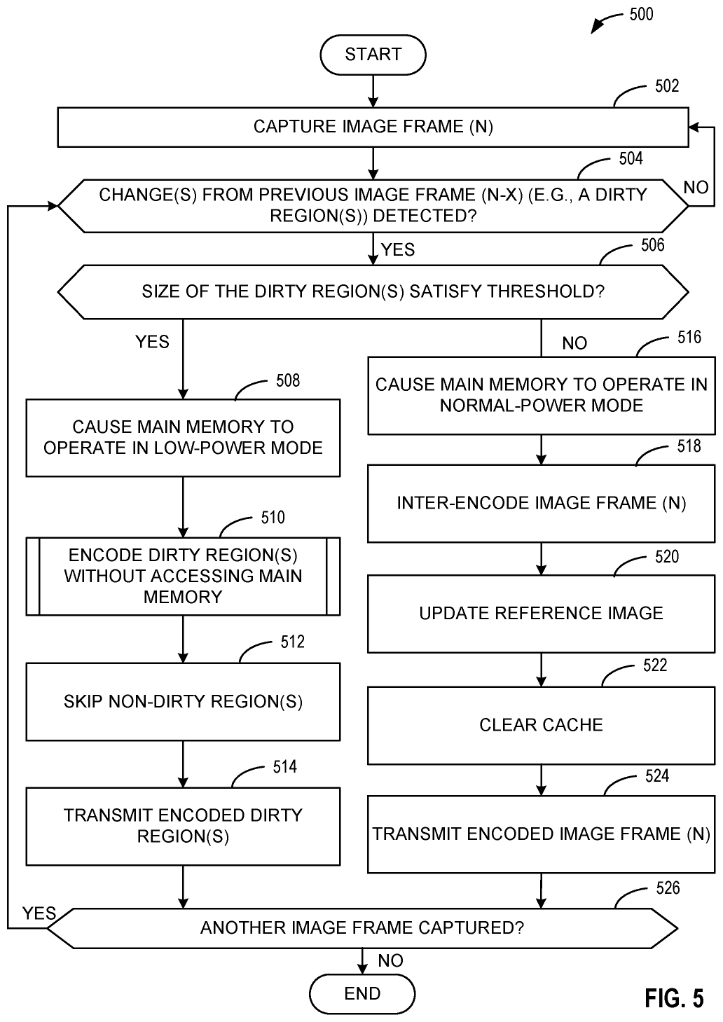

The example image processing circuitry 220 of FIG. 2 includes image generation circuitry 222 to generate images (e.g., graphics) for display at the display screen 112. Specifically, the image generation circuitry 222 generates frame data and updates the display screen 202 with the frame data. For example, the image generation circuitry 222 can output a signal(s) to the display screen 112 to control an illumination of pixels of the display screen and, in turn, the image displayed by the display screen 112. In some examples, the image generation circuitry 222 sends an image to the display screen 112 based on information received from the first programmable circuitry 205. For example, the application processing circuitry 207 can determine an image to be presented based on an input received by the user input device(s) 204 and/or machine readable instructions associated with the user application(s) 210 and/or the image sharing application 212. In some examples, the application processing circuitry 207 causes the image generation circuitry 222 to adjust the image based on input from the user received via the user input device(s) 204. For example, the image generation circuitry 222 can cause the display screen 112 to render and/or remove a rendering of alphanumeric characters based on input from the user received via a keyboard of the user input device(s) 204. In some examples, the application processing circuitry 207 causes the image generation circuitry 222 to obtain the image based on an input received from the camera 108 (e.g., during a video conference). In some examples, the image generation circuitry 222 is instantiated by programmable circuitry executing display control instructions and/or configured to perform operations such as those represented by the flowchart(s) of FIGS. 5 and/or 6.

The example programmable circuitry 208 of FIG. 2 includes a cache 224. The example cache 224 stores one or more encoded portions (e.g., a dirty region(s)) of an image(s) previously encoded by the image processing circuitry 220. The image processing circuitry 220 selectively utilizes the cache 224 to store the encoded dirty region(s) based on a size of the dirty region(s) and available space in the cache 224, as discussed in further detail below. As used herein, a “dirty region” encompasses an image portion at a location of an image frame that includes pixel value changes relative to pixel values at a same location of a previous image frame. In some examples, for a region of an image to be considered a “dirty region” the changes or differences between its pixels and pixel values of a previous image frame are to satisfy a pixel change threshold. For example, the pixel change threshold can be selected as a sufficiently high level to prevent noise or visually imperceptible differences between a previous and current pixel value from causing a “dirty region” designation.

The example image processing circuitry 220 of FIG. 2 includes detection circuitry 228. The example detection circuitry 228 can detect a dirty region(s) in an image frame. For example, a portion of an image frame (N) may include text that was highlighted by the user through the user input device(s) 204 between the image frame (N) and the previous image (N−1). In some examples, the detection circuitry 228 can identify an uncovered portion of a background in an image captured by the camera 108. In some examples, the detection circuitry 228 detects a portion in a current frame that is changed relative to a previous frame (e.g., a dirty region) based on information received from the user application(s) 210 operating at the local user device 102. In some examples, the detection circuitry 228 detects a dirty region by using any suitable dirty region detection technique such as a dirty rectangles technique and/or a scrolled rectangle technique. The example detection circuitry 228 indicates (e.g., transmits a signal(s) indicative of) a location of the dirty region to the encoder circuitry 230. In some examples, the detection circuitry 228 is instantiated by programmable circuitry executing detection instructions and/or configured to perform operations such as those represented by the flowchart(s) of FIGS. 5 and/or 6.

The example image processing circuitry 220 of FIG. 2 includes encoder circuitry 230. The example encoder circuitry 230 can encode image(s) within the local user device 102. For example, the encoder circuitry 230 can encode an image generated by the camera 108, the user application(s) 210, the image sharing application 212, and/or the image generation circuitry 222 (e.g., a GPU and/or a CPU). In some examples, the encoder circuitry 230 encodes only a portion of the image. For example, the encoder circuitry 230 can encode only a dirty region.

The example local user device 202 includes a second volatile memory 219. The example second volatile memory 219 includes and/or implements an image transmission buffer 231. In some examples, the encoder circuitry 230 writes the encoded image frame to the image transmission buffer 231. The image transmission buffer 231 is a temporary storage, where image data is temporarily stored between capture and transmission. Accordingly, after capture and prior to transmission, the encoder circuitry 230 encodes (e.g., compresses) the image data in the image transmission buffer 231.

In the example of FIG. 2, to determine how to encode one or more dirty region(s) detected by the detection circuitry 228, the encoder circuitry 230 determines a dirty region size of the one or more dirty region(s). The example encoder circuitry 230 compares the dirty region size to a threshold. For example, the threshold can be a size of available cache space in the cache 224. In some examples, the threshold is based on the available cache space in the cache plus a size of an overlap in area of the image frame occupied by the detected dirty region(s) and dirty regions previously encoded and stored in the cache 224. When the dirty region size satisfies (e.g., is less than or equal to) the threshold, the encoder circuitry 230 encodes the dirty region(s) and stores the encoded dirty region without accessing the first volatile memory 214. For example, the encoder circuitry 230 encodes the dirty region(s) and stores the encoded dirty region using the cache 224. As a result, the image processing circuitry 220 reduces an amount of memory accesses, which enables the first volatile memory 214 to be in a low-power (e.g., sleeping) state thereby reducing a consumption of power from the power source 216. The example encoder circuitry 230 stores the encoded dirty region(s) with metadata indicative of pixel locations (e.g., horizontal by vertical coordinates) of the dirty region in the corresponding image frame in the cache 224. For example, each cache line in the cache 224 can be tagged with metadata indicative of the location of the dirty region within the corresponding image frame. The dirty region is stored in an encoded (e.g., compressed) format on the cache line.

In some examples, after determining that an encoded version of one or more detected dirty region(s) is to be stored via the cache 224, the encoder circuitry 230 determines how to encode the dirty region(s). Specifically, the encoder circuitry 230 determines whether inter-encoding can be performed using encoded frame data from one or more previous image frame(s) stored in the cache 224. Specifically, the example encoder circuitry 230 determines whether the detected dirty region(s) or a portion of the dirty region(s) match a previous dirty region(s) stored in the cache 224. For example, the encoder circuitry 230 can perform a motion vector search in the cache 224 to determine whether some or all of the encoded previous dirty regions in the cache 224 match any of the detected dirty region(s) in the image transmission buffer 231. When the encoder circuitry 230 identifies a match in the cache 224, the encoder circuitry 230 inter-encodes the dirty region(s) using the matching ones of the previous dirty region(s). For example, the encoder circuitry 230 performs inter-encoding by using the matching ones of the previous dirty region(s) as a reference, such as by copying the encoded previous dirty region(s) for a different location in the image frame (e.g., a location of the dirty region in the current image frame). That is, when encoding the image frame using inter-encoding, the encoder circuitry 230 encodes the dirty region(s) of the image frame based on a relationship between sequential image frames (e.g., a current image frame (N) and a previous image frame (N−X)).

In some examples, when the encoder circuitry 230 determines that inter-encoding is not to be utilized to encode the detected dirty region(s), the encoder circuitry 230 determines whether to delete and/or overwrite data stored in the cache 224. In some examples, the encoder circuitry 230 determines whether the location of the detected dirty region(s) overlaps with a location(s) of an encoded dirty region(s) stored in the cache 224 from a previous image frame. In such examples, the encoder circuitry 230 searches the cache 224 to identify whether a location of the previously encoded dirty region(s) overlaps with the location of the current dirty region(s). When the location of the current dirty region(s) does not overlap with the location(s) of previously encoded dirty region(s) stored in the cache 224, the encoder circuitry 230 intra-encodes the dirty region(s) and copies the previous dirty region(s) from the cache 224 for transmission of an encoded version of the current image frame. When generating an encoded image frame with intra-encoding, the example encoder circuitry 230 encodes the dirty region(s) of the video frame without referencing a previous video frame. Further, the example encoder circuitry 230 encodes the remainder of the video frame (e.g., a portion of the video frame not covered by the previous dirty region(s) nor the current dirty region(s)) as a skip block(s). In examples disclosed herein, a skip block marks a region as “no change” or “skip” as a result of negligible change occurring in the region relative to the previous image frame. As a result, a decoder of another user device (e.g., the remote user device 106a,b,n) that receives the encoded image frame can reconstruct the region by copying the corresponding area of the previous image frame.

In some examples, when the location of the dirty region(s) overlaps with the location(s) of a previous dirty region(s) stored in the cache 224, the encoder circuitry 230 removes the previous dirty region(s) or portion thereof from the cache 224. In such examples, the encoder circuitry 230 copies a remainder of the previous dirty region(s) from the cache 224 to the image transmission buffer 231. In such examples, the encoder circuitry 230 intra-encodes the current dirty region(s). As such, the encoded dirty region(s) of the current video frame or a portion thereof overwrites the encoded dirty region(s) of the previous video frame or a portion thereof that is overlapped by the current dirty region(s). In some examples, the encoder circuitry 230 updates metadata in the cache 224 indicative of the location(s) of the previous encoded dirty region(s) based on the previous dirty region(s) or portion thereof that was overlapped by the current dirty region(s). The example encoder circuitry 230 encodes the remainder of the video frame (e.g., a portion of the video frame not covered by the encoded previous dirty region(s) nor the encoded current dirty region(s)) as a skip block(s).

In the example of FIG. 2, when the dirty region size of the dirty region(s) does not satisfy (e.g., is greater than) the threshold, the encoder circuitry 230 inter-encodes the video frame as a whole (e.g., encodes an entirety of the video frame). Specifically, when the dirty region size of the dirty region(s) does not satisfy the threshold, the encoder circuitry 230 references a reference frame 232 (e.g., a reference image) in the first volatile memory 214 to inter-encode the video frame. Additionally, the example encoder circuitry 230 updates the reference frame 232 in the first volatile memory 214 with the current video frame after encoding the current video frame. In some examples, the encoder circuitry 230 replaces portions of the reference frame 232 with the dirty region(s) stored in the cache 224 and/or identified in the current video frame. In some examples, the encoder circuitry 230 encodes the whole current video frame and causes the encoded video frame to be the reference frame 232 (e.g., overwrites the previous reference frame with the encoded video frame). Further, when the dirty region size of the dirty region(s) does not satisfy the threshold, the example encoder circuitry 230 clears the cache 224 to make additional space for subsequent dirty region(s).

In the example of FIG. 2, the example encoder circuitry 230 causes the encoded video frame stored in the image transmission buffer 231 or the main memory 214 to be transmitted to one or more user device(s) 235 (e.g., the remote user devices 106 of FIG. 1). The encoded video frame may be transmitted to the output user device(s) 235 via one or more protocol(s) (e.g., voice-over-internet protocol(s)) associated with the image sharing application 212. In the example of FIG. 2, the encoded image is transmitted to the output user device(s) 235 via the network 104. Additionally, the output user device(s) 235 can transmit image(s) via one or more protocol(s) to the local user device 102. In the example of FIG. 2, output user device(s) 235 transmits image(s) to the local user device 102 via the network 104. In some examples, the encoder circuitry 230 is instantiated by programmable circuitry executing encoder instructions and/or configured to perform operations such as those represented by the flowchart(s) of FIGS. 5 and/or 6.

The example image processing circuitry 220 of FIG. 2 includes memory power control circuitry 233 to control a power state of the first volatile memory 214. When the dirty region size of the dirty region(s) satisfies the threshold and the first volatile memory 214 is not utilized to encode the video frame, the memory power control circuitry 233 causes the first volatile memory 214 to operate in a low-power state (e.g., a sleep mode). Specifically, when the encoder circuitry 230 does not reference the reference frame 232 stored in the first volatile memory 214 to encode the video frame, the memory power control circuitry 233 causes the second voltage regulator circuitry 213 to deliver a reduced amount of power to the first volatile memory 214 to put the first volatile memory 214 in the low-power state. As a result, the image processing circuitry 220 reduces a power that the local user device 102 consumes and, in turn, improves an energy efficiency and battery life of the local user device 102. When the first size of the dirty region(s) does not satisfy the threshold and the reference frame 232 in the first volatile memory 214 is to be utilized and updated, the example memory power control circuitry 233 causes the second voltage regulator 213 to adjust the first volatile memory 214 to a normal operating state (e.g., wakes up the first volatile memory 214). In some examples, the memory power control circuitry 233 is instantiated by programmable circuitry executing memory power control instructions and/or configured to perform operations such as those represented by the flowchart of FIG. 5.

The example image processing circuitry 220 of FIG. 2 includes decoder circuitry 234. The example decoder circuitry 234 can decode the image(s) received from the output user device(s) 235. For example, the decoder circuitry 234 can use decoding standards such as H.264 advanced video coding (AVC). In other examples, other decoding standards can be used by the decoder circuitry 234. In some examples, the decoder circuitry 234 can decode only a portion of each of the image(s). For example, the decoder circuitry 234 can determine (e.g., via motion vectors and skip blocks) that a portion of the image is substantially unchanged from a previous image. The example decoder circuitry 234 can then decode only the portion of the image that is changed from the previous image. The example decoder circuitry 234 can provide the decoded image(s) and/or the decoded portion of the image(s) to the image generation circuitry 222. As a result, the image generation circuitry 222 can cause the decoded image(s) to be presented via the display screen 112.

The example image processing circuitry 220 of FIG. 2 includes scaler and format converter (SFC) circuitry 236. The example SFC circuitry 236 can scale and/or convert a format of the image(s) decoded by the decoder circuitry 234. Additionally, the example SFC circuitry 236 facilitates transfer of the image(s) out of the decoder circuitry 234. For example, the example SFC circuitry includes an internal storage buffer. The internal storage buffer of the example SFC circuitry 236 is directly connected to the decoder circuitry 234. Therefore, the internal storage buffer of the SFC circuitry 236 can receive image(s) from the decoder circuitry 234 directly (e.g., without reading and writing from the first volatile memory 214). In some examples, the decoder circuitry 234 writes the decoded image(s) into a grid view buffer.

In the illustrated example of FIG. 2, the image generation circuitry 222 controls a presentation of the decoded images. As mentioned above, the image generation circuitry 222 controls a composition of a frame (e.g., the frame data), which can include the decoded image(s) from the grid view and user interface components from the image sharing application 212. In some examples, the frame data includes the metadata from the grid view buffer indicating the changed portions of the image(s). The example image generation circuitry 222 updates the display screen 112 with the frame data in order to display the decoded image(s). In some examples, the image generation circuitry 222 reads the metadata included in the frame data to determine the changed portions of the frame data. In these examples, the image generation circuitry 222 can selectively update the display screen 202 with only the changed portions.

In the example of FIG. 2, the image processing circuitry 220 is implemented by executable instructions executed on the programmable circuitry 208 of the local user device 102. However, in other examples, the image processing circuitry 220 is implemented by programmable circuitry 240 of another user device 242 (e.g., a smartphone, an edge device, a wearable device, etc.) in communication with the local user device 102 (e.g., via wired or wireless communication protocols), by programmable circuitry of the output user devices(s) 235, and/or by a cloud-based device 104 (e.g., one or more server(s), processor(s), and/or virtual machine(s)). In other examples, the image processing circuitry 220 is implemented by dedicated circuitry located on the local user device 102, the output user device(s) 235, and/or another user device(s) 242. These components may be implemented in software, hardware, or in any combination of two or more of software, firmware, and/or hardware.

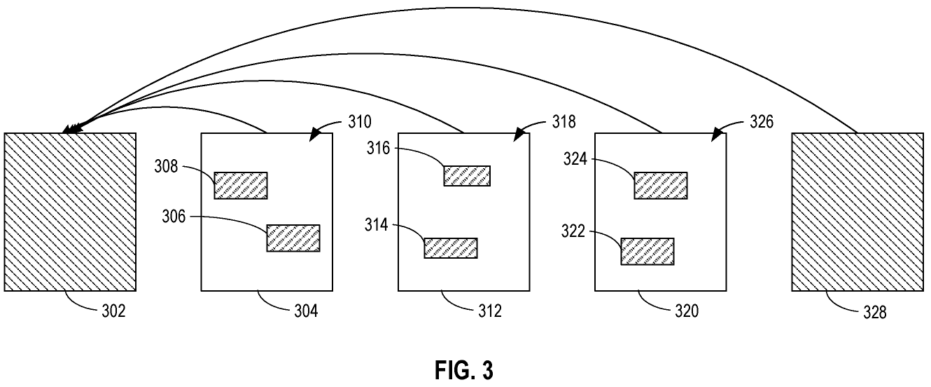

FIG. 3 illustrates a first example of video frame encoding performed by the image processing circuitry 220 of FIG. 2. In the example of FIG. 3, the local user device 102 generates a first image frame 302. Specifically, the encoder circuitry 230 encodes an entirety of the first image frame 302. For example, when the first image frame 302 is an initial image frame in a video, the encoder circuitry 230 encodes the first image frame 302 via intra-encoding. When the first image frame 302 is not the initial image frame in the video, the encoder circuitry 230 can encode the first image frame 302 via inter-encoding that references another video frame (e.g., an earlier video frame). Accordingly, the local user device 102 can transmit the encoded first image frame 302 to other user device(s) (e.g., the remote user device(s) 106a,b,n, the output user device(s) 235, the user device(s) 242). Further, the encoder circuitry 230 stores the first image frame 302 in the first volatile memory 214 as a reference image frame (e.g., the reference frame 232 of FIG. 2).

In the example of FIG. 3, the local user device 102 generates a second image frame 304. The example second image frame 304 includes a first dirty region 306, a second dirty region 308, and a first remainder region 310 (e.g., an unchanged region). The example detection circuitry 228 of FIG. 2 detects the dirty regions 306, 308 and determines respective locations thereof. In this example, the example encoder circuitry 230 determines that there is sufficient storage space in the cache 224 of FIG. 2 to store an encoded version of the dirty regions 306, 308 and their respective locations. In some examples, the encoder circuitry 230 intra-encodes the first dirty region 306 and intra-encodes the second dirty region 308 without reference to a previous frame and stores the encoded dirty regions 306, 308 with their respective locations in the cache 224. In some examples, the encoder circuitry 230 searches for at least a partial match between the dirty regions 306, 308 and previous dirty regions stored in the cache 224. In such examples, when the encoder circuitry 230 identifies at least a partial match, the encoder circuitry 230 inter-encodes the dirty regions 306, 308, or the portion thereof corresponding to the match, using the previous dirty region(s) stored in the cache 224 as a reference. Thus, the encoder circuitry 230 can inter-encode the dirty regions 306, 308 without accessing the first volatile memory 214. Further, the example encoder circuitry 230 encodes the first remainder region 310 as a skip block. Specifically, although the encoder circuitry 230 references the first image frame 302 for the first remainder region 310, the encoder circuitry 230 does not read the first image frame 302 from the first volatile memory 214 and encodes the region that did not change relative to the first image frame 302 (e.g., the first remainder region 310) as a skip block.

In the example of FIG. 3, the local user device 102 generates a third image frame 312. The example third image frame 312 includes a third dirty region 314, a fourth dirty region 316, and a second remainder region 318. The example detection circuitry 228 of FIG. 2 detects the dirty regions 314, 316 and determines respective locations thereof. The example encoder circuitry 230 determines that there is sufficient storage space in the cache 224 to store an encoded version of the dirty regions 314, 316 and their respective locations. In some examples, the encoder circuitry 230 intra-encodes the third dirty region 314 and intra-encodes the fourth dirty region 316 without reference to a previous frame. In some examples, the encoder circuitry 230 inter-encodes the dirty regions 314, 316 using a previous dirty region(s) stored in the cache 224 as a reference. The example encoder circuitry 230 stores the encoded dirty regions 314, 316 with their respective locations in the cache 224. Further, the example encoder circuitry 230 encodes the second remainder region 318 as a skip block.

In the example of FIG. 3, the local user device 102 generates a fourth image frame 320. The example fourth image frame 320 includes a fifth dirty region 322, a sixth dirty region 324, and a third remainder region 326. The example detection circuitry 228 of FIG. 2 detects the dirty regions 322, 324 and determines respective locations thereof. In this example, the example encoder circuitry 230 determines that there is sufficient storage space in the cache 224 of FIG. 2 to store an encoded version of the dirty regions 322, 324 and their respective locations. In some examples, the encoder circuitry 230 intra-encodes the fifth dirty region 322 and the sixth dirty region 324 without reference to a previous frame. In some examples, the encoder circuitry 230 inter-encodes the dirty regions 322, 324 using a previous dirty region(s) stored in the cache 224 as a reference. The example encoder circuitry 230 stores the encoded dirty regions 322, 324 with their respective locations in the cache 224. Further, the example encoder circuitry 230 encodes the third remainder region 326 as a skip block.

In the example of FIG. 3, the local user device 102 generates a fifth image frame 328. In this example, the encoder circuitry 230 determines that a size of an encoded version of a dirty region(s) in the fifth image frame 328 and its associated location is greater than a size of the available storage space in the cache 224. Specifically, the storage space in the cache 224 is occupied by the dirty regions 306, 308, 314, 316, 322, 324 of the second, third, and fourth image frames 304, 312, 320 such that there is not enough room to store the dirty region(s) in the fifth image frame 328. As a result, the encoder circuitry 230 inter-encodes the fifth image frame 328 with reference to the first image frame 302. After inter-encoding the fifth image frame 328, the encoder circuitry 230 can cause the fifth image frame 328 to replace the first image frame 302 as the reference image frame (e.g., the reference frame 232 of FIG. 2) in the first volatile memory 214.

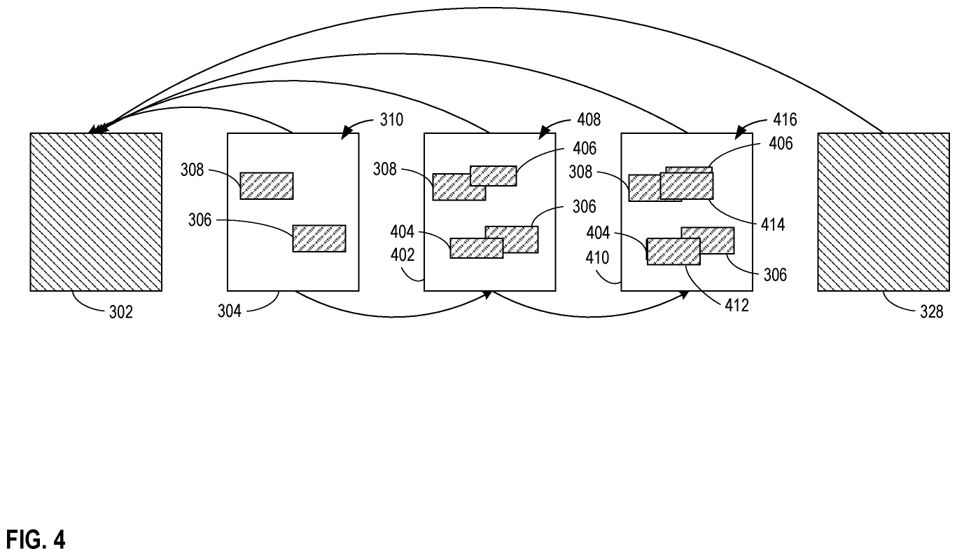

FIG. 4 illustrates a second example of video frame encoding performed by the image processing circuitry 220 of FIG. 2. In the example of FIG. 3, the local user device 102 generates the reference image 302, and the encoder circuitry 230 encodes and stores the reference image 302 in the first volatile memory 214 of FIG. 2, as discussed above. Further, the local user device 102 generates the second image frame 304 including the first dirty region 306, the second dirty region 308, and the first remainder region 310, as also discussed above.

In the example of FIG. 4, the local user device 102 generates a third image frame 402 including a third dirty region 404, a fourth dirty region 406, a first portion of the first dirty region 306, a first portion of the second dirty region 308, and a second remainder region 408. Specifically, the third dirty region 404 overlaps a second portion of the first dirty region 306, and the fourth dirty region 406 overlaps a second portion of the second dirty region 308. In this example, the encoder circuitry 230 searches for at least a partial match between the dirty regions 404, 406 and previous dirty regions stored in the cache 224 (e.g., the first dirty region 306, the second dirty region 308, etc.). In such examples, when the encoder circuitry 230 identifies at least a partial match, the encoder circuitry 230 inter-encodes the dirty regions 404, 406, or the portion(s) thereof corresponding to the match, using the previous dirty region(s) stored in the cache 224 (e.g., the first dirty region 306, the second dirty region 308, etc.) as a reference. In some examples, when the encoder circuitry 230 does not identify a match, the encoder circuitry 230 intra-encodes the third dirty region 404 and intra-encodes the fourth dirty region 406. In such examples, the encoder circuitry 230 erases the second portion of the first dirty region 306 from the cache 224 and updates the metadata corresponding to the location of the first dirty region 306 to be indicative of only the first portion. Similarly, the encoder circuitry 230 can erase the second portion of the second dirty region 308 from the cache 224 and update the metadata corresponding to the location of the second dirty region 306 to be indicative of only the first portion. Further, the example encoder circuitry 230 encodes the second remainder region 408 as a skip block. The example second remainder region 408 corresponds to an area of the image frame 402 not covered by the first, second, third, or fourth dirty regions 306, 308, 404, 406.

In the example of FIG. 4, the local user device 102 generates a fourth image frame 410 including a fifth dirty region 412, a sixth dirty region 414, a third portion of the first dirty region 306, a third portion of the second dirty region 308, a first portion of the third dirty region 404, a first portion of the fourth dirty region 406, and a third remainder region 416. Specifically, the fifth dirty region 412 partially overlaps the first portion of the first dirty region 306 and overlaps a second portion of the third dirty region 404. Similarly, the sixth dirty region 414 partially overlaps the first portion of the second dirty region 308 and overlaps a second portion of the fourth dirty region 406. In this example, the encoder circuitry 230 searches for at least a partial match between the dirty regions 412, 414 and previous dirty regions stored in the cache 224 (e.g., the first dirty region 306, the second dirty region 308, the third dirty region 404, the fourth dirty region, 406, etc.). In such examples, when the encoder circuitry 230 identifies at least a partial match, the encoder circuitry 230 inter-encodes the dirty regions 412, 414 or the portion(s) thereof corresponding to the match, using the previous dirty region(s) stored in the cache 224 (e.g., the first dirty region 306, the second dirty region 308, the third dirty region 404, the fourth dirty region, 406, etc.). In some examples, when the encoder circuitry 230 does not identify a match, the encoder circuitry 230 intra-encodes the fifth dirty region 412 and intra-encodes the sixth dirty region 414. In such examples, the encoder circuitry 230 erases the portions of the first, second, third, and fourth dirty regions 306, 308, 404, 406 overlapped by the fifth and sixth dirty regions 412, 414 from the cache 224 and updates the metadata indicative of their corresponding locations accordingly. Further, the example encoder circuitry 230 encodes the third remainder region 416 as a skip block. The example third remainder region 416 corresponds to an area of the image frame 410 not covered by the first, second, third, fourth, fifth, or sixth dirty regions 306, 308, 404, 406, 412, 414. In the example of FIG. 4, the local user device 102 generates the fifth image frame 328, and the encoder circuitry 230 encodes the fifth image frame 328, as discussed above in association with FIG. 3.

While an example manner of implementing the local user device 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example image processing circuitry 220, the image generation circuitry 222 the detection circuitry 228, the encoder circuitry 230, the memory power control circuitry 233, the decoder circuitry 234, the SFC circuitry 236, and/or, more generally, the example local user device 102 of FIG. 2, may be implemented by hardware alone or by hardware in combination with software and/or firmware. Thus, for example, any of the example image processing circuitry 220, the image generation circuitry 222 the detection circuitry 228, the encoder circuitry 230, the memory power control circuitry 233, the decoder circuitry 234, the SFC circuitry 236, and/or, more generally, the example local user device 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example local user device 102 of FIG. 2 may include one or more elements, processes, and/or devices in addition to, or instead of, those illustrated in FIG. 2, and/or may include more than one of any or all of the illustrated elements, processes and devices.

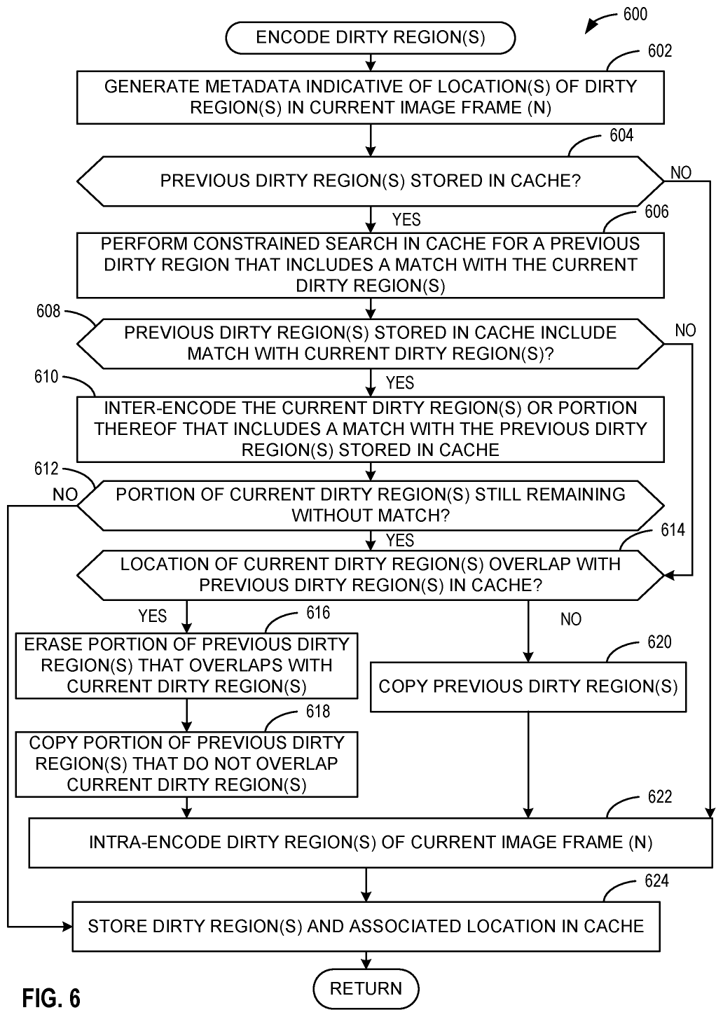

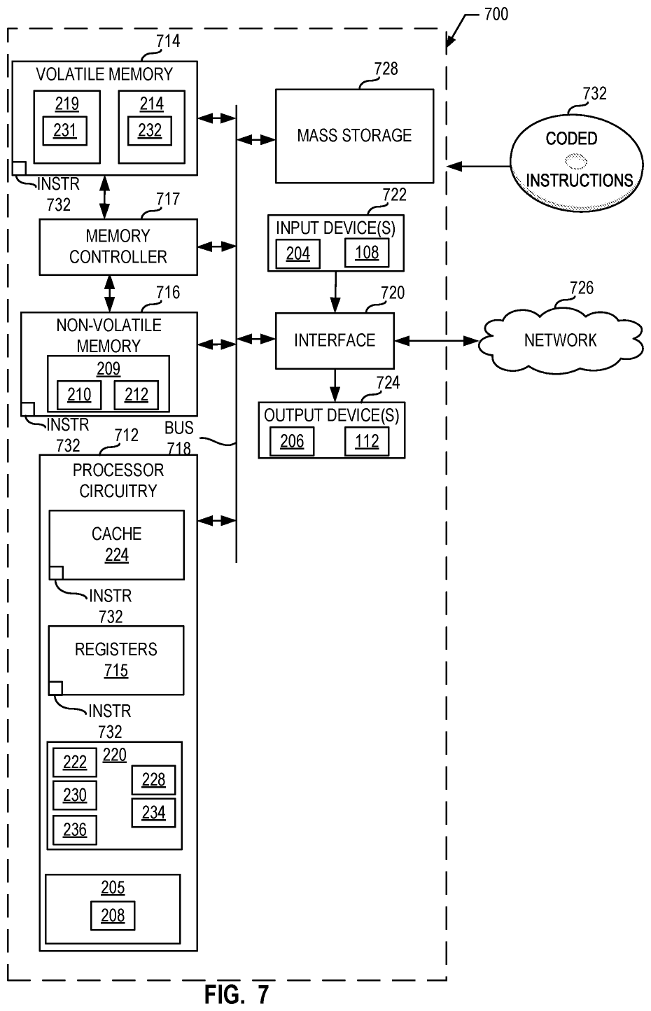

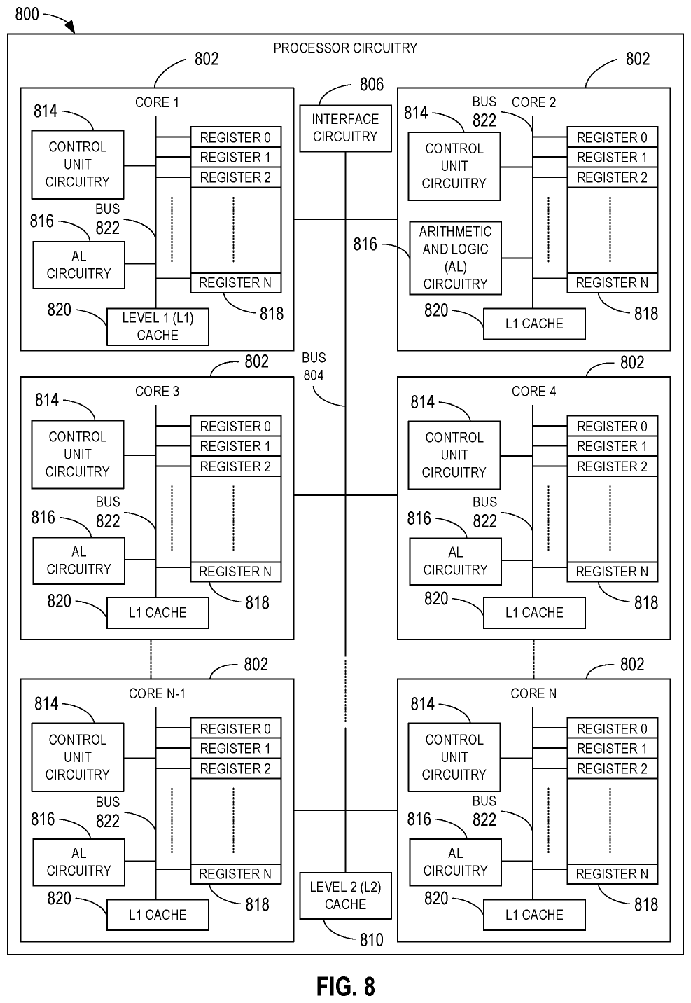

Flowchart(s) representative of example machine readable instructions, which may be executed by programmable circuitry to implement and/or instantiate the local user device 102 of FIG. 2 and/or representative of example operations which may be performed by programmable circuitry to implement and/or instantiate the local user device 102 of FIG. 2, are shown in FIGS. 5-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-6, many other methods of implementing the example local user device 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to reduce memory (e.g., first volatile memory 214) access through utilization of a cache (e.g., the cache 224 of FIG. 2) during video frame encoding. The example machine-readable instructions and/or the example operations 500 of FIG. 5 begin at block 502, at which the local user device 102 (FIGS. 1-2) generates an image frame (N). For example, the camera 108 (FIGS. 1-2) and/or the image generation circuitry 222 (FIG. 2) can generate the image frame (N). In some examples, the image generation circuitry 222 generates the image frame (N) based on information received from the application processing circuitry 207. The display screen 112 can present the generated image frame (N).

At block 504, the local user device 102 determines whether the image frame (N) includes a change relative to a previous image frame (N−1). For example, the application processing circuitry 207 (FIG. 2) can determine whether the image frame (N) includes one or more dirty region(s) based on one or more changes relative to the previous image frame (N−X). In some examples, the detection circuitry 228 (FIG. 2) accesses dirty region information generated by the application processing circuitry 207. In some examples, the application processing circuitry 207 and/or the detection circuitry 228 determines a location(s) of the dirty region(s) within the image frame (N).

At block 506, the local user device 102 determines whether a size of the detected dirty region(s) satisfies (e.g., is less than or equal to) a pixel quantity threshold. In some examples, the pixel quantity threshold is based on an available storage space in the cache 224. For example, the encoder circuitry 230 (FIG. 2) can determine a size of the detected dirty region(s) based on the determined location of the dirty region(s). Further, the encoder circuitry 230 can compare the dirty region size to the available cache space in the cache 224. In some examples, the pixel quantity threshold is based on an amount of overlap between (i) an area within the image frame occupied by the detected dirty region(s) and (ii) an area within the image frame occupied by one or more previously encoded dirty region(s) stored in the cache. In such examples, the pixel quantity threshold corresponds to the available cache space plus an amount of space that corresponds with the amount of overlap. In some examples, the encoder circuitry 230 determines the amount of overlap. In turn, the encoder circuitry 230 can determine the pixel quantity threshold and whether the size of the detected dirty region(s) satisfies the threshold. When the size of the dirty region(s) satisfies the pixel quantity threshold the operations 500 proceed to block 508. Otherwise, when the size of the dirty region(s) does not satisfy (e.g., is greater than) the pixel quantity threshold, control proceeds to block 516.

At block 508, when the size of the dirty region(s) satisfies the pixel quantity threshold, the local user device 102 causes the first volatile memory 214 (FIG. 2) to operate in a low-power mode (e.g., a sleep mode, a low-power state). For example, the memory power control circuitry 233 (FIG. 2) can cause the second voltage regulator circuitry 213 to deliver a reduced voltage and/or electrical current to the first volatile memory 214, which causes the first volatile memory 214 to enter or remain in the low-power mode when the dirty region size can fit in the cache 224. This is based on the expectation that accesses to the first volatile memory 214 will not be performed because the cache 224 includes sufficient space to hold data of interest. In some examples, the second voltage regulator circuitry 213 causes the first volatile memory 214 to operate in the low-power mode after not receiving a read or write request for at least a threshold period of time. In other examples, the memory power control circuitry 233 can cause the main memory 214 to operate in the low-power mode by setting a low-power mode value in a configuration register of the second voltage regulator circuitry 213 and/or the first volatile memory 214.

At block 510, the local user device 102 encodes the dirty region(s) without accessing the first volatile memory 214. For example, the encoder circuitry 230 can encode the dirty region(s) and store the encoded dirty region(s) with their determined location via the cache 224. Example instructions that may be used to implement block 510 are described below in conjunction with FIG. 6.

At block 512, the local user device 102 skips a non-dirty region (e.g., a remainder) of the image frame. For example, the encoder circuitry 230 can encode the remainder of the image frame as a skip block.

At block 514, the local user device 102 transmits the encoded dirty region(s). For example, the encoder circuitry 230 can transmit the encoded dirty region(s) to another device (e.g., the remote user device 106a,b,n (FIG. 1), the user device(s) 242 (FIG. 2)). After block 514, control proceeds to block 526.

At block 516, the local user device 102 causes the first volatile memory 214 to operate in a normal-power mode. For example, the memory power control circuitry 233 can cause the second voltage regulator circuitry 213 to wake up the first volatile memory 214. In some examples, the first volatile memory 214 wakes up in response to receiving a read or write request from the encoder circuitry 230.

At block 518, the local user device 102 inter-encodes the image frame (N). For example, the encoder circuitry 230 can inter-encode the image frame (N) by referencing the reference frame 232 (FIG. 2) stored in the first volatile memory 214 when the size of the dirty region(s) does not satisfy the pixel quantity threshold.

At block 520, the local user device 102 updates the reference frame 232. For example, the encoder circuitry 230 can update the reference frame 232 with the image frame (N). In some examples, the encoder circuitry 230 replaces a full image corresponding to the reference frame 232 with the image frame (N) (e.g., performs a full re-write of the reference frame 232). In some examples, to reduce processing resources utilized to update the reference frame 232, the encoder circuitry 230 replaces a portion(s) of the image corresponding to the reference frame 232 with the dirty region(s) in the image frame (N) and dirty region(s) in a previous image frame (N−X) stored in the cache 224.

At block 522, the local user device 102 clears the cache 224. For example, the encoder circuitry 230 can delete the previous dirty region(s) stored in the cache 224 after replacing the reference frame 232. As a result, the encoder circuitry 230 makes more room in the cache 224 for subsequent image frames (N+Y).

At block 524, the local user device 102 transmits the encoded image frame (N). For example, the encoder circuitry 230 can transmit the inter-encoded image frame (N) (e.g., the reference frame 232) to another device (e.g., the remote user device 106a,b,n (FIG. 1), the user device(s) 242 (FIG. 2)).

At block 526, the local user device 102 determines whether another image frame has been captured. When another image frame has been captured, the operations 500 return to block 504. Otherwise, the operations 500 terminate.

FIG. 6 is a flowchart representative of example machine readable instructions and/or example operations 600 that may be executed, instantiated, and/or performed by programmable circuitry to implement block 510 of FIG. 5 to encode the dirty region(s) of the image frame without accessing the first volatile memory 214. The operations 600 begin at block 602, at which the local user device 102 generates metadata indicative of a location(s) of a dirty region(s) in the current image frame (N) (e.g., current dirty region(s)). For example, the detection circuitry 228 and/or the encoder circuitry 230 can generate the metadata based on the determined location(s) of the dirty region(s).

At block 604, the local user device 102 determines whether one or more previous dirty region(s) is stored in the cache 224. For example, the encoder circuitry 230 can search the cache 224 for the previous dirty region(s). When the cache 224 includes previous dirty region(s), control proceeds to block 606. Otherwise, when the cache 224 does not include a previous dirty region(s), control advances to block 622.

At block 606, the local user device 102 performs a constrained search (e.g., a limited search) in the cache 224 for a previous dirty region(s) that includes a match with the current dirty region(s). For example, the encoder circuitry 230 can perform a motion vector search in the cache 224 for at least a portion of (e.g., a 16×16 block of pixel data, a 32×32 block of pixel data, a 64×64 block of pixel data) the current dirty region(s) to determine whether there is a match between motion vectors of the current dirty region(s) and motion vectors of the previous dirty region(s) that can be utilized to encode the current dirty region(s).

At block 608, when the previous dirty region(s) stored in the cache 224 include motion vectors matching motion vectors of the current dirty region(s), control proceeds to block 610. Otherwise, when the previous dirty region(s) stored in the cache 224 do not include motion vectors matching motion vectors of at least a portion of the current dirty region(s), control advances to block 614.

At block 610, the local user device 102 inter-encodes the current dirty region(s) or a portion of the current dirty region(s) that includes a match with the previous dirty region(s) stored in the cache 224. For example, the encoder circuitry 230 can read the previous dirty region(s) or the portion of the previous dirty region(s) that matches the current dirty region(s) or the portion of the current dirty region(s) from the cache 224. In such examples, the encoder circuitry 230 inter-encodes the current dirty region(s) using the previous dirty region(s) as a reference.

At block 612, the local user device 102 determines whether a portion of the current dirty region(s) is still remaining without a match with the previous dirty region(s). For example, the encoder circuitry 230 can determine whether the inter-encoded dirty region(s) only covered a portion of the current dirty region(s). When a portion of the current dirty region(s) without a match remain for encoding after inter-encoding the portion that matches the previous dirty region(s), control proceeds to block 614. Otherwise, when the inter-encoding covered all of the dirty region(s) of the current image frame (N), the operations 600 skip to block 624.

At block 614, the local user device 102 determines whether the location of the current dirty region(s) overlaps with the previous dirty region(s) stored in the cache 224. For example, the encoder circuitry 230 can compare the location of the current dirty region(s) to the location(s) of the previous dirty region(s) stored in the cache 224 to determine whether there is an overlap. When the encoder circuitry 230 identifies an overlap, control proceeds to block 616. Otherwise, when the encoder circuitry 230 does not identify an overlap, the operations 600 proceed to block 620.

At block 616, the local user device 102 erases the previous dirty region(s) or portion of the previous dirty region(s) that overlap with the current dirty region(s). For example, the encoder circuitry 230 can erase the previous dirty region(s) or portion thereof in the cache 224. In such examples, when only a portion of the previous dirty region(s) is erased, the encoder circuitry 230 updates the location metadata for the previous dirty region(s) in the cache 224 to reflect the erasure of the portion.

At block 618, the local user device 102 copies the previous dirty region(s) or a portion(s) of the previous dirty region(s) that do not overlap with the current dirty region(s). For example, the encoder circuitry 230 can copy the previous dirty region(s) or the portion(s) of the previous dirty region(s) that do not overlap with the current dirty region(s) from the cache 224 to the image transmission buffer 231 (FIG. 2) in the second volatile memory 219 (FIG. 2). After block 618, control proceeds to block 622.

At block 620, the local user device 102 copies the previous dirty region(s) to the image transmission buffer 231. For example, the encoder circuitry 230 can copy the previous dirty region(s) from the cache 224 to the image transmission buffer 231 when the encoder circuitry 230 does not identify an overlap between the previous dirty region(s) and the current dirty region(s).

At block 622, the local user device 102 intra-encodes the dirty region(s) of the current image frame (N). For example, the encoder circuitry 230 can intra-encode the portion of the current image frame (N).

At block 624, the local user device 102 stores the current dirty region(s) and the associated location of the dirty region(s) in the cache 224. For example, the encoder circuitry 230 can store the dirty region(s) of the current image frame (N) with the metadata indicative of the location of the dirty region(s) adjacent to (e.g., in front of) the dirty region(s) in the cache 224. The example instructions and/or operations 600 end and control returns to the example instructions and/or operations 500 of FIG. 5.

FIG. 7 is a block diagram of an example programmable circuitry platform 700 structured to execute and/or instantiate the example machine-readable instructions and/or the example operations of FIGS. 5-6 to implement the local user device 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the second programmable circuitry 712 implements the image processing circuitry 220 including the image generation circuitry 222, the detection circuitry 228, the encoder circuitry 230, the memory power control circuitry 233, the decoder circuitry 234, and the SFC circuitry 236. In this example, the programmable circuitry 712 also implements the first programmable circuitry 205 including the application processing circuitry 207.

The programmable circuitry 712 of the illustrated example includes the cache 224, and registers 715. The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. In the example of FIG. 7, the volatile memory 714 (i) implements the first volatile memory 214 (FIG. 2) and includes the reference frame 232 (FIG. 2) and (ii) implements the second volatile memory 219 (FIG. 2) and includes the image transmission buffer 231(FIG. 2). More particularly, the volatile memory 714 implements the first volatile memory 214 and the second volatile memory 219 separately (e.g., as separate DRAMs. The non-volatile memory 716 may be implemented by flash memory and/or any other desired type of memory device. In the example of FIG. 7, the non-volatile memory 716 implements the non-volatile memory 209 (FIG. 2) and includes the user application(s) 210 (FIG. 2) and the image sharing application 212 (FIG. 2). Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system. In this example, the input device(s) 722 implements the user input device(s) 204 and the camera 108.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. In this example, the output device(s) implements the output device(s) 206 and the display screen 112. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5-6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

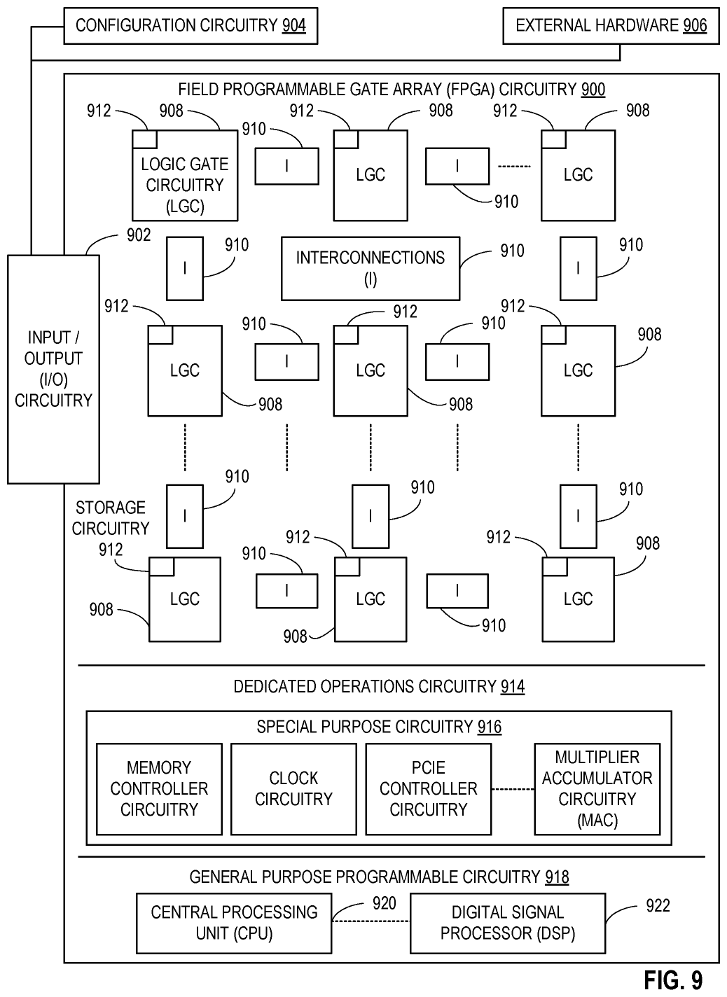

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-6. As such, the FPGA circuitry 900 may be configured and/or structured to effectively instantiate some or all of the operations/functions corresponding to the machine readable instructions of the flowchart(s) of FIGS. 5-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 5-6, and/or an ASIC may be configured and/or structured to perform third operation(s)/function(s) corresponding to a third portion of the machine readable instructions represented by the flowcharts of FIGS. 5-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

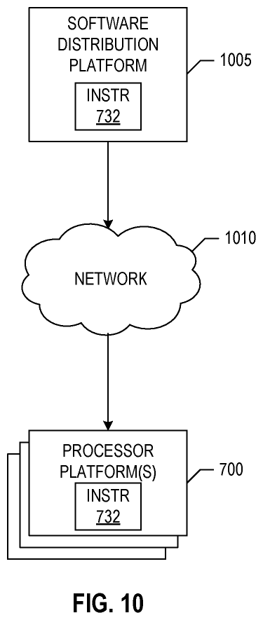

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 5-6, may be downloaded to the example programmable circuitry platform 700, which is to execute the machine readable instructions 732 to implement the local user device 102. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide significant reductions in power consumption and memory bandwidth usage during for image encoding. More particularly, the disclosed examples enable a main memory to be maintained in a low-power state during image frame encoding to minimize or otherwise reduces accesses of the main memory that would otherwise utilize limited bandwidth and cause the memory to consume power.

Example methods and apparatus to utilize cache in image encoding are disclosed herein. Further examples and combinations thereof include the following:
Example 1 includes an apparatus comprising interface circuitry, machine readable instructions, and programmable circuitry to at least one of instantiate or execute the machine readable instructions to determine a size of a dirty region of a video frame, after the size of the dirty region satisfies a threshold encode the dirty region of the video frame to generate an encoded dirty region, and cause storing of the dirty region in cache, and after the size of the dirty region does not satisfy the threshold cause storing of the video frame in a volatile memory that is separate from the cache, and encode the video frame via inter-encoding to generate an encoded video frame.
Example 2 includes the apparatus of example 1, wherein the programmable circuitry is to after the size of the dirty region satisfies the threshold, cause the encoded dirty region to be transmitted to a remote device, and after the size of the dirty region does not satisfy the threshold, cause the encoded video frame to be transmitted to the remote device.
Example 3 includes the apparatus of example 1, wherein, after the size of the dirty region satisfies the threshold, the programmable circuitry is to encode the dirty region of the video frame via intra-encoding to generate the encoded dirty region.
Example 4 includes the apparatus of example 1, wherein the programmable circuitry is to determine whether the dirty region of the video frame at least partially matches a previous dirty region stored in the cache, after the dirty region of the video frame matches the previous dirty region stored in the cache, inter-encode the dirty region to generate the encoded dirty region, and after the dirty region of the video frame does not match the previous dirty region stored in the cache, intra-encode the dirty region to generate the encoded dirty region.
Example 5 includes the apparatus of example 1, wherein, after the size of the dirty region satisfies the threshold, the programmable circuitry is to determine a location of the dirty region in the video frame, determine whether the location overlaps with one or more previous dirty regions stored in the cache, after the location overlaps with the one or more previous dirty regions stored in the cache, delete an overlapped portion of the one or more previous dirty regions from the cache, and after the location does not overlap with the one or more previous dirty regions stored in the cache, copy the one or more previous dirty regions from the cache to an image transmission buffer.
Example 6 includes the apparatus of example 1, wherein the programmable circuitry is to cause the main memory to be in a low-power state when the size of the dirty region satisfies the threshold.
Example 7 includes the apparatus of example 1, wherein, after the size of the dirty region does not satisfy the threshold, the programmable circuitry is to clear the cache.
Example 8 includes the apparatus of example 1, wherein, after the size of the dirty region does not satisfy the threshold, the programmable circuitry is to replace a reference image stored in the volatile memory with the video frame.
Example 9 includes the apparatus of example 1, wherein, after the size of the dirty region does not satisfy the threshold, the programmable circuitry is to update a reference image stored in the volatile memory based on one or more partial image frames stored in the cache.
Example 10 includes the apparatus of example 1, wherein the threshold is based on an available cache space in the cache.
Example 11 includes a non-transitory machine readable storage medium comprising instructions to cause programmable circuitry to at least determine a size of a dirty region of an image frame, after the size of the dirty region satisfies a threshold that corresponds with an available storage space in a cache, encode the dirty region without accessing a memory to generate an encoded dirty region, the memory separate from the cache, and after the size of the dirty region does not satisfy the threshold, encode the image frame via inter-encoding that includes accessing the memory to generate an encoded image frame.
Example 12 includes the non-transitory machine readable storage medium of example 11, wherein the size is a first size, and wherein the instructions cause the programmable circuitry to after the first size of the dirty region satisfies the threshold, cause the encoded dirty region to be transmitted to a remote device, and after the first size of the dirty region does not satisfy the threshold, cause the encoded image frame to be transmitted to the remote device, wherein the encoded image frame is a second size greater than the first size.
Example 13 includes the non-transitory machine readable storage medium of example 11, wherein the instructions are to cause the programmable circuitry to determine whether a first area of the image frame occupied by the dirty region overlaps with a second area of a previous dirty region stored in the cache, after the first area overlaps with the second area replace at least a portion of the previous dirty region with the dirty region, copy a portion of the previous dirty region not overlapped by the first area to an image transmission buffer, and encode the dirty region to generate the encoded dirty region, and after the first area does not overlap with the second area, encode the dirty region to generate the encoded dirty region.
Example 14 includes the non-transitory machine readable storage medium of example 11, wherein, after the size of the dirty region does not satisfy the threshold, the instructions cause the programmable circuitry to clear the cache.
Example 15 includes the non-transitory machine readable storage medium of example 11, wherein, after the size of the dirty region does not satisfy the threshold, the instructions are to cause the programmable circuitry to replace a reference image stored in the memory with the image frame.
Example 16 includes the non-transitory machine readable storage medium of example 11, wherein, after the size of the dirty region does not satisfy the threshold, the instructions are to cause the programmable circuitry to update a reference image stored in the memory based on one or more partial image frames stored in the cache.
Example 17 includes a method comprising determining whether a size of a dirty region of an image frame satisfies a threshold, the threshold based on an available storage space in a cache, when the size satisfies the threshold storing the dirty region via the cache, encoding, by executing an instruction with programmable circuitry, the dirty region to generate an encoded dirty region, and skipping encoding of a non-dirty region of the image frame, and when the size does not satisfy the threshold storing the image frame via memory separate from the cache, and inter-encoding, by executing an instruction with programmable circuitry, the image frame to generate an encoded image frame.
Example 18 includes the method of example 17, further including after the size of the dirty region satisfies the threshold, causing the encoded dirty region to be transmitted to a remote device, and after the size of the dirty region does not satisfy the threshold, causing the encoded image frame to be transmitted to the remote device.
Example 19 includes the method of example 17, wherein the dirty region is a first dirty region, further including determining whether the first dirty region in the image frame matches a second dirty region stored in the cache, after the first dirty region matches the second dirty region, inter-encoding the first dirty region to generate the encoded dirty region, and after the first dirty region does not match the second dirty region, intra-encoding the first dirty region to generate the encoded dirty region.
Example 20 includes the method of example 17, further including clearing the cache after the size of the dirty region does not satisfy the threshold.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
determine a size of a dirty region of a video frame;
after the size of the dirty region satisfies a threshold, the threshold based on an available cache space in cache:
encode the dirty region of the video frame to generate an encoded dirty region; and
cause storing of the encoded dirty region in the cache; and
after the size of the dirty region does not satisfy the threshold:
cause storing of the video frame in a volatile memory that is separate from the cache; and
encode the video frame via inter-encoding to generate an encoded video frame.

2. The apparatus of claim 1, wherein the programmable circuitry is to:
after the size of the dirty region satisfies the threshold, cause the encoded dirty region to be transmitted to a remote device; and
after the size of the dirty region does not satisfy the threshold, cause the encoded video frame to be transmitted to the remote device.

3. The apparatus of claim 1, wherein, after the size of the dirty region satisfies the threshold, the programmable circuitry is to encode the dirty region of the video frame via intra-encoding to generate the encoded dirty region.

4. The apparatus of claim 1, wherein the programmable circuitry is to:
determine whether the dirty region of the video frame at least partially matches a previous dirty region stored in the cache;
after the dirty region of the video frame matches the previous dirty region stored in the cache, inter-encode the dirty region to generate the encoded dirty region; and
after the dirty region of the video frame does not match the previous dirty region stored in the cache, intra-encode the dirty region to generate the encoded dirty region.

5. The apparatus of claim 1, wherein, after the size of the dirty region satisfies the threshold, the programmable circuitry is to:
determine a location of the dirty region in the video frame;
determine whether the location overlaps with one or more previous dirty regions stored in the cache;
after the location overlaps with the one or more previous dirty regions stored in the cache, delete an overlapped portion of the one or more previous dirty regions from the cache; and
after the location does not overlap with the one or more previous dirty regions stored in the cache, copy the one or more previous dirty regions from the cache to an image transmission buffer.

6. The apparatus of claim 1, wherein the programmable circuitry is to cause the volatile memory to be in a low-power state when the size of the dirty region satisfies the threshold.

7. The apparatus of claim 1, wherein, after the size of the dirty region does not satisfy the threshold, the programmable circuitry is to clear the cache.

8. The apparatus of claim 1, wherein, after the size of the dirty region does not satisfy the threshold, the programmable circuitry is to replace a reference image stored in the volatile memory with the video frame.

9. The apparatus of claim 1, wherein, after the size of the dirty region does not satisfy the threshold, the programmable circuitry is to update a reference image stored in the volatile memory based on one or more partial image frames stored in the cache.

10. A non-transitory machine readable storage medium comprising instructions to cause programmable circuitry to at least:
determine a size of a dirty region of an image frame;
after the size of the dirty region satisfies a threshold that corresponds with an available storage space in a cache, encode the dirty region without accessing a memory to generate an encoded dirty region, the memory separate from the cache; and
after the size of the dirty region does not satisfy the threshold, encode the image frame via inter-encoding that includes accessing the memory to generate an encoded image frame.

11. The non-transitory machine readable storage medium of claim 10, wherein the size is a first size, and wherein the instructions cause the programmable circuitry to:
after the first size of the dirty region satisfies the threshold, cause the encoded dirty region to be transmitted to a remote device; and
after the first size of the dirty region does not satisfy the threshold, cause the encoded image frame to be transmitted to the remote device, wherein the encoded image frame is a second size greater than the first size.

12. The non-transitory machine readable storage medium of claim 10, wherein the instructions are to cause the programmable circuitry to:
determine whether a first area of the image frame occupied by the dirty region overlaps with a second area of a previous dirty region stored in the cache;
after the first area overlaps with the second area:
replace at least a portion of the previous dirty region with the dirty region;
copy a portion of the previous dirty region not overlapped by the first area to an image transmission buffer; and
encode the dirty region to generate the encoded dirty region; and
after the first area does not overlap with the second area, encode the dirty region to generate the encoded dirty region.

13. The non-transitory machine readable storage medium of claim 10, wherein, after the size of the dirty region does not satisfy the threshold, the instructions cause the programmable circuitry to clear the cache.

14. The non-transitory machine readable storage medium of claim 10, wherein, after the size of the dirty region does not satisfy the threshold, the instructions are to cause the programmable circuitry to replace a reference image stored in the memory with the image frame.

15. The non-transitory machine readable storage medium of claim 10, wherein, after the size of the dirty region does not satisfy the threshold, the instructions are to cause the programmable circuitry to update a reference image stored in the memory based on one or more partial image frames stored in the cache.

16. The non-transitory machine readable storage medium of claim 10, wherein the instructions are to cause the memory to be in a low-power state after the size of the dirty region satisfies the threshold.

17. A method comprising:
determining whether a size of a dirty region of an image frame satisfies a threshold, the threshold based on an available storage space in a cache;
when the size satisfies the threshold:
storing the dirty region via the cache;
encoding, by executing an instruction with programmable circuitry, the dirty region to generate an encoded dirty region; and
skipping encoding of a non-dirty region of the image frame; and
when the size does not satisfy the threshold:
storing the image frame via memory separate from the cache; and
inter-encoding, by executing an instruction with programmable circuitry, the image frame to generate an encoded image frame.

18. The method of claim 17, further including:
after the size of the dirty region satisfies the threshold, causing the encoded dirty region to be transmitted to a remote device; and
after the size of the dirty region does not satisfy the threshold, causing the encoded image frame to be transmitted to the remote device.

19. The method of claim 17, wherein the dirty region is a first dirty region, further including:
determining whether the first dirty region in the image frame matches a second dirty region stored in the cache;
after the first dirty region matches the second dirty region, inter-encoding the first dirty region to generate the encoded dirty region; and
after the first dirty region does not match the second dirty region, intra-encoding the first dirty region to generate the encoded dirty region.

20. The method of claim 17, further including clearing the cache after the size of the dirty region does not satisfy the threshold.
